(19) United States
(12) Patent Application Publication
(10) Pub. No.: US 2008/0218322 A1
(43) Pub. Date: Sep. 11, 2008

(54) Release Signal Authentication Method of Immobilizer

(75) Inventor: Takahiro Shii, Shizuoka (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA MOTOR ELECTRONICS KABUSHIKI KAISHA, Shizuoka-ken (JP)

(21) Appl. No.: 12/041,412

(22) Filed: Mar. 3, 2008

(30) Foreign Application Priority Data
Mar. 8, 2007 (JP) 2007-057946

(51) Int. Cl. B60R 25/10

(52) U.S. Cl. 340/426.11

(57) ABSTRACT

In a release signal authentication method for an immobilizer, a main switch can be turned on in a state that a battery is not mounted or the like, power is supplied to a CPU by power generation resulting from manual rotation of the engine, a release signal can be inputted by the user in a state that the engine is rotating, and the rotation of the engine is continued if the release signal matches with a release signal registered in advance. Further, in the release signal authentication method for an immobilizer, an input of the release signal can be given by operating an electrical apparatus using voltage supplied by the main switch, the release signal can be discriminated in the CPU, and the release signal can be discriminated only when a voltage amount supplied to the main switch is equal to or higher than a voltage amount that the CPU can recognize that the main switch is in a ON-state.

### PRIORITY INFORMATION

This application is based on and claims priority to Japanese Patent Application No. 2007-057946, filed Mar. 8, 2007, the entire contents of which is hereby expressly incorporated by reference.

### BACKGROUND OF THE INVENTIONS

1. Field of the Inventions

The present inventions relate to release signal authentication methods for operating an immobilizer and for authenticating a release signal of an anti-theft device.

2. Description of the Related Art

Authentication of a release signal (ID) is often performed by an immobilizer to prevent an unauthorized engine operation, such as during a theft or the like, when an engine of a vehicle is being started. The authentication process by the immobilizer needs electric power, which is typically supplied by a battery. However, there are some cases in which electric power for ID authentication is not available, for example, when a battery is disconnected, or when voltage of the battery is low (hereinafter referred to as “with the battery open”). In such cases, the engine cannot be started, and thus it is not possible to drive the vehicle.

To solve the above ID authentication failure problem with the battery open, a device has been proposed for preventing an unpermitted operation of an engine based on ID verification, in which a power generator is operated by starting an engine before the ID verification to secure power supply voltage necessary for the ID verification with the battery open, and the engine operation is continued or stopped according to a result of the verification. This device prohibits the engine operation after a predetermined period of time and stops the engine when the authentication fails, for example, when an ID is not verified or when an ID is not an input. Such a device is described in Japanese Patent Document JP-A-2001-18753.

### SUMMARY OF THE INVENTIONS

An aspect of at least one of the embodiments disclosed herein includes the realization that when a voltage output from a main switch is not sufficient, and when the user turns on an electrical apparatus to issue a signal corresponding to a release code, the signal is not properly recognized by the CPU, and therefore the electrical apparatus is recognized to be off Because of such incorrect recognition in the CPU, even when having input a correct release signal, the user cannot release the anti-theft device. As a result, the user cannot drive the vehicle.

Thus, in accordance with an embodiment, a release signal authentication method for an immobilizer can be provided in which a user can turn on a main switch and can manually perform an operation for rotating an engine in a state that a battery is not be mounted or battery voltage is not sufficient for rotating the engine. A power source can be configured to be supplied to a CPU by power generation resulting from rotation of the engine and a release signal can be configured to be input by the user in a state that the engine is rotating. An anti-theft device can be configured to be released and the rotation of the engine is sustained when the inputted release signal matches with a release signal registered in advance. The method can comprise inputting the release signal by operating an electrical apparatus using voltage supplied by turning on the main switch and detecting the inputted release signal with the CPU only when a voltage amount supplied to the main switch is equal to or higher than a voltage amount that the CPU can recognize that the main switch is in an ON-state.

In accordance with another embodiment, a release signal authentication method can be provided for an immobilizer of a vehicle having an engine. The method can comprise determining if a first output voltage of a main switch of the vehicle is greater than a first predetermined voltage level and detecting an output signal of an electrical apparatus of the vehicle only if the first output voltage is greater than the first predetermined voltage level. The method can also comprise comparing the output signal of the electrical apparatus to a predetermined release code of the immobilizer and allowing the engine to continue to operate if the output signal of the electrical apparatus matches the release code.

In accordance with yet another embodiment, an immobilizer apparatus for a vehicle having an engine can comprise an electrical apparatus configured to be actuatable by a user of the vehicle and to output an output signal corresponding to actuation. A central processing unit (CPU) can have a release code stored therein, the release code corresponding to a predetermined pattern of actuation of the electrical apparatus. A main switch can be provided that a user can turn on. A power source can be configured to supply power to the CPU by power generation resulting from rotation of the engine. Additionally, the CPU can be configured to recognize that the main switch is activated only if the voltage received from the main switch is equal to or greater than a first predetermined voltage value. The CPU can also be configured to detect signal changes from the electrical apparatus only if an output signal of the electrical apparatus is greater than a second voltage value that is less than the first predetermined voltage value. Additionally, the CPU can be configured to compare the output signal of the electrical apparatus with the release code and to allow the engine to continue to operate only if the output signal corresponds to the release code.

In accordance with another embodiment, an immobilizer apparatus for a vehicle having an engine, can comprise an electrical apparatus configured to be actuatable by a user of the vehicle and to output an output signal corresponding to actuation. A storage device can have a release code stored therein, the release code can correspond to a predetermined pattern of actuation of the electrical apparatus. A main switch that a user can turn on a power source configured to supply power to the main switch and the electrical apparatus from rotation of the engine. Additionally, the apparatus can include means for recognizing that the main switch is activated only if the voltage received from the main switch is equal to or greater than a first predetermined voltage value, for detecting signal changes from the electrical apparatus only if an output signal of the electrical apparatus is greater than a second voltage value that is less than the first predetermined voltage value, and for comparing the output signal of the electrical apparatus with the release code and for allowing the engine to continue to operate only if the output signal corresponds to the release code.

### BRIEF DESCRIPTION OF THE DRAWINGS

The above-mentioned and other features of the inventions disclosed herein are described below with reference to the drawings of preferred embodiments. The illustrated embodiments are intended to illustrate, but not to limit the inventions. The drawings contain the following Figures:

FIG. 1 shows a flow chart of the release signal authentication method for an immobilizer according to an embodiment.

FIG. 2 shows a schematic view of an anti-theft device that can be used with the release signal authentication method.

FIG. 3 shows a schematic view of another anti-theft device that can be used with the release signal authentication method.

FIG. 4 shows a schematic view illustrating exemplary voltage detection sensitivity of the first transistor and the second transistor.

FIG. 5 shows a schematic drawing illustrating how a change in ON/OFF signals of the electrical apparatus can be recognized.

FIG. 6 shows a chart illustrating a relation between voltage and time in a main switch that can result at a time when the engine is manually started with the battery open.

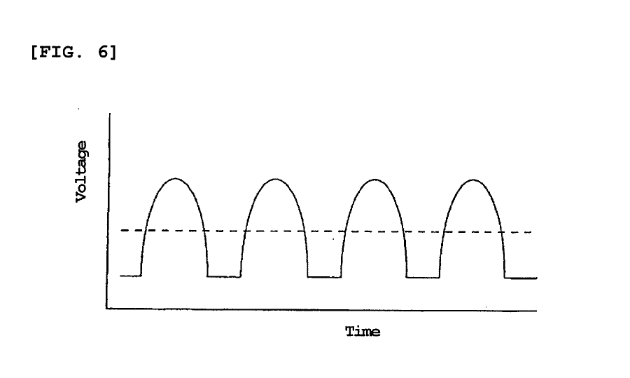

### DETAILED DESCRIPTION OF THE PREFERRED EMBODIMENT

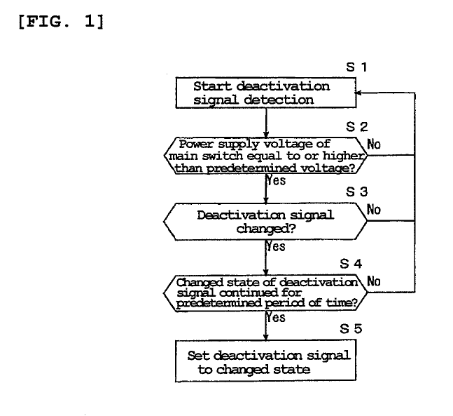

FIG. 1 illustrates a flow chart of the release signal authentication sequence of an immobilizer in accordance with several embodiments. The various embodiments of the release signal authentication systems and methods are disclosed in the context of a straddle vehicle because they have particular utility in this context. However, the authentication methods and systems disclosed herein can be used in other contexts, such as, for example, but without limitation, non-straddle vehicles, and for authentication methods of other vehicles including land vehicles and water vehicles.

Some of the embodiments disclosed herein can include a release signal authentication method for an immobilizer, in which a user turns on a main switch and manually performs an operation for rotating an engine in a state that a battery is not mounted or battery voltage is not sufficient for rotating the engine. As such, power can be supplied to a CPU by power generation resulting from rotation of the engine. A release signal can be input by the user in a state that the engine is rotating, and the rotation of the engine is continued by releasing an anti-theft device if the release signal input as described above matches with a release signal registered in advance. Further, in some embodiments of a release signal authentication method for an immobilizer, an input of the release signal can be given by operating an electrical apparatus using voltage supplied by turning on the main switch, the release signal inputted is discriminated in the CPU. In some embodiments, the release signal is discriminated only when a voltage amount supplied to the main switch is equal to or more than a voltage amount that the CPU can recognize that the main switch is in the ON-state.

With reference to the flow chart of FIG. 1, in the step S1, before driving a straddle vehicle provided with an anti-theft device, the user turns on a main switch. Consequently, a power generator provided to an engine and, optionally, a Capacitive Discharge Ignition (CDI) unit (which can be used as an ignition control device for the engine) can be energized. The user can manually rotate the engine with a kick starter, push-starting, or the like with the battery open. Consequently, power from the power generator can be supplied to the CDI unit and, in addition, to the CPU, as well as other devices that, in some embodiments, are used for engine operation. For example, such other devices might include electric fuel pumps, fuel injectors, sensors, etc. With power being supplied by way of rotation of the engine, a detection process for detecting the release signal of an immobilizer by the CPU can start. In other words, this can be a step for the CPU to start determining whether or not the inputted release signal is an actual input by the user.

At the beginning of the step S2, the CPU can determine whether or not a level of power supply voltage at the main switch is equal to or higher than a first predetermined voltage level. This first predetermined voltage level can be defined so that the CPU can reliably recognize that the main switch is in the ON-state. Via the main switch, electrical power can be supplied to the electrical apparatus where the user inputs the release signal.

Accordingly, when a voltage level of the main switch is equal to or higher than the first predetermined voltage level, the CPU can detect the release signal of the user's input. On the other hand, when a voltage level of the main switch is equal to or lower than the first predetermined level, the CPU does not perform detection of the release signal, which can prevent an incorrect or less reliable recognition that can result from low voltage operation of the main switch. Therefore, if the voltage level of the main switch is equal to or lower than the first predetermined level, the CPU resumes and repeats the step S1 to check the voltage level of the main switch.

In the step S3, if the voltage level of the main switch is equal to or higher than the predefined voltage level in the step S2, the CPU determines whether the release signal (“deactivation signal”) has changed or not. For example, whether the release signal has just been turned on or not is determined if the release signal has been OFF. The CPU performs this determination by detecting an ON/OFF state of the switch of the electrical apparatus operated by the user. The CPU is configured to return to the step S1 if the release signal has not changed.

In the step S4, when the release signal has changed in the step S3, the CPU determines whether the change continues for a predetermined period of time or not. This determination is performed to surely detect the release signal input by the user regardless of ON/OFF signals of the input switch resulting from a so-called “chattering”. When there is a change in the release signal, a contact point of the switch of the electrical apparatus can be turned on from off or turned off from on. At this time, the change does not instantly occur, but a state can be repeatedly shifted between ON and OFF several times in a phenomenon which is called “chattering”. This is why the release signal input by the user can be surely detected by ensuring that the state has sustained for the predetermined period of time after the change. If the state after the change of the release signal has not sustained for the predetermined period of time, the chattering can still be occurring. Accordingly, the detected release signal is configured to be invalid, and the CPU is returns to the step S1.

In the Step S5, if the state in which the release signal is changed has sustained for the predetermined period of time in the step S4, the release signal is to be set, assuming that the release signal in the state has been input. In other words, the CPU can define whether the release signal is ON or OFF for the first time. After this, if a number in the input release signal does not match with the release signal to release the immobilizer registered in advance, the CPU is configured to resume the step 1 to discriminate a next release signal. If the release signal matches with the registered release signal, the immobilizer is configured to be released, and the rotation of the engine is configured to continue. If the release signal is different from the registered release signal, the rotation of the engine is stopped, for example, by disabling the CDI, disabling fuel injectors, altering fuel injection to prevent or reduce combustion in the engine, disabling fuel pumps, closing a throttle valve of the engine (for example, where an electronic throttle valve is used), disabling valve actuation (where the engine include controllable intake and/or exhaust valves), or by other methods.

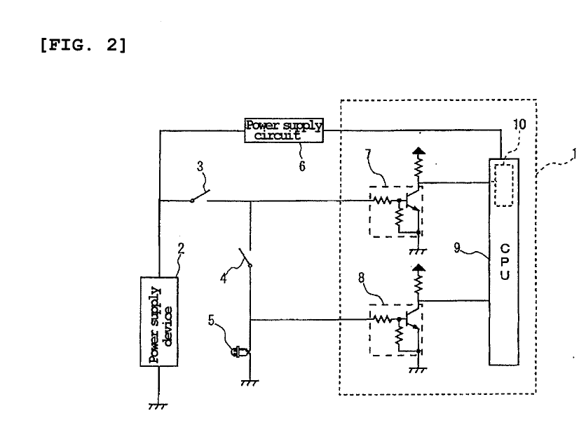

FIG. 2 shows a schematic view of an anti-theft device used for the release signal authentication method for an immobilizer according to some embodiments.

As illustrated in the drawing, an immobilizer 1 can be used as an anti-theft device in some embodiments. The immobilizer 1 can be placed in a main body of a straddle vehicle (not shown) such as a motorcycle.

The main body of the vehicle can be provided with a power supply apparatus 2 comprising a power generator driven by an engine (not shown) such as a generator or alternator and associated circuitry, a main switch 3, and a brake switch 4. The brake switch 4 can be the electrical apparatus from which the user can input the release signal. Thus, in some embodiments, a user can input the release signal by turning on or off the brake switch, for example, by squeezing and releasing an associated brake lever (not shown) operatively connected to the brake switch 4.

The brake switch 4 can be for a front wheel brakes or for a rear wheel brakes (not shown). The electrical apparatus can also be other electrical apparatuses such as, for example but without limitation, a hazard lamp or a high-beam which can be supplied with electric power by the power supply apparatus 2 via the main switch 3. A brake lamp 5 can be lit according to an input from the brake switch 4.

The immobilizer 1 can be provided with a CPU 9, which can serve as the CPU referred to above in the description of the flow chart of FIG. 1. After the main switch 3 is turned on by the user, and when the engine is manually rotated, electric power from the power supply apparatus 2 can be supplied to the CPU 9 via a power supply circuit 6. In other words, the power supply circuit 6 can be configured to supply electric power from the power supply apparatus 2 to the CPU 9 regardless of an input of the main switch 3. A first transistor 7 can be placed between the main switch 3 and the CPU 9, while a second transistor 8 can be placed between the brake switch 4 and the CPU 9.

The transistor 7 can be configured to be turned on when voltage equal to or higher than a first predetermined level is applied to the base terminal from the main switch 3, and such that an electric current (not shown) flows from the power supply circuit 6 through the transistor 7 to the CPU 9. Further, the transistor 8 can be configured to be turned on when voltage equal to or higher than another predetermined level, which can be the same or different from the first predetermined level, is applied to the base terminal from the brake switch 4, and such that an electric current (not shown) flows from the power supply circuit 6 through the transistor 8 to the CPU 9.

An A/D (analog-to-digital) converter 10 can be contained in the CPU 9. The A/D converter 10 can be configured to enable the CPU 9 to recognize a voltage of the main switch 3.

Thus, the CPU 9 can determine whether or not a voltage level supplied to the main switch 3 is equal to or higher than the first predetermined voltage level which is set to be a threshold for recognizing that the main switch 3 is turned on. The CPU 9 can also be configured to detect the release signal input from the brake switch 4 only when the voltage level of the main switch 3 is equal to or higher than the predetermined voltage level. As a result, the ON signal and the OFF signal of the brake switch 4 can be reliably recognized by the CPU 9, and an incorrect recognition that the ON signal of the brake switch 4 is off that would result during low voltage operation of the main switch 3 can be prevented. The A/D converter 10 can be mounted separately from the CPU 9.

If the voltage amount of the main switch 3 is equal to or lower than the predetermined voltage amount, the release signal may not be accurately detected. Accordingly, if the user inputs the release signal under such condition, there may be the case that the release signal is not adequately recognized. However, the period of time that the voltage level of the main switch 3 is equal to or lower than the predetermined voltage level may be only for about 5 ms, whereas it may take 40 to 50 ms for a person to perform an operation to input the release signal. Therefore, the inputted release signal can be surely recognized in the CPU 9.

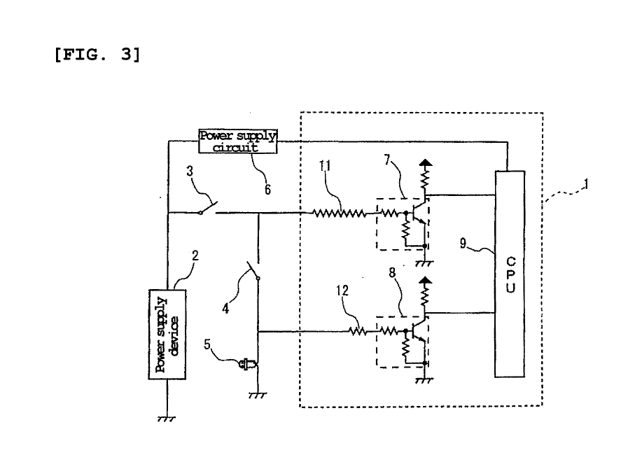

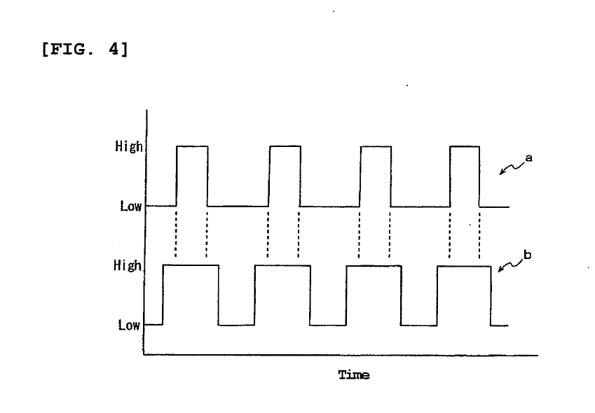

FIG. 3 shows a schematic view of another anti-theft device used for the release signal authentication method of an immobilizer according to the present invention. FIG. 4 shows a schematic view illustrating voltage detection sensitivity of the first transistor 7 and the second transistor 8.

As illustrated in FIG. 3, resistor devices 11 and 12 can be connected in front of the base terminal of each transistor to change voltage detection sensitivity of the first transistor 7 and the second transistor 8. The resistance value of the resistor device 11 can be higher than the resistant value of the resistor device 12. As the resistor device 11 is configured to be placed in front of the first transistor 7, the first transistor 7 can detect only voltages that are higher than voltages detected by the second transistor 8. In other words, the voltage detection sensitivity of the first transistor 7 can be lower than the voltage detection sensitivity of the second transistor 8.

With the resistor device 11 connected as such, the switch mechanism of the first transistor 7 is not turned on if the voltage level of the main switch 3 is equal to or lower than the first predetermined voltage level. Accordingly, the CPU 9 can determine whether or not the voltage level of the main switch 3 is equal to or higher than the first predetermined level.

As described above, the voltage detection sensitivity of the first transistor 7 is set to be lower than the voltage detection sensitivity of the second transistor 8. Accordingly, if the voltage level of the main switch 3 is equal to or higher than the first predetermined level, sufficient voltage can more reliably be applied to the brake switch 4. As a result, the release signal can more reliably be detected in the CPU 9.

Part of the operation described above is schematically illustrated in FIG. 4. In FIG. 4, a voltage level which can turn on the switch mechanism of the transistor is indicated as “High” while any other voltage levels are indicated as “Low.” In addition, the line “a” on the upper part of FIG. 4 indicates a voltage level of the main switch 3 detected by the first transistor 7 and the line “b” on the lower part of FIG. 4 indicates a voltage level of the brake switch 4 detected by the second transistor 8. The abscissa represents time. The width of “High” voltage detected by the second transistor 8 is longer than “High” voltage detected by the first transistor 7. This is because voltage levels recognized as “High” by the first transistor 7 and the second transistor 8 are different, and the resistor devices 11 and 12 are placed so that the voltage level recognized as “High” by the first transistor 7 is higher than the voltage level recognized as “High” by the second transistor 8. Therefore, when the first transistor 7 is in a state of “High,” the second transistor 8 is always in a state of “High.” In other words, detection of a release signal input to the brake switch 4 can be performed only in a case in which a voltage level of the main switch 3 is equal to or higher than a voltage level so that the CPU 9 can recognize that the main switch 3 is in the ON-state.

Devices other than the resistor devices 11 and 12 can also be used for adjusting the voltage detection sensitivity of the first transistor 7 and the second transistor 8. For example, a mechanism for adjusting voltage detection sensitivity can be provided to the transistors 7, 8 by hFE (hFE stands for the small signal Forward Current Gain of a bipolar junction transistor) or the like.

As described above, the CPU 9 is configured to detect the release signal input with the brake switch 4 only when the voltage level of the main switch 3 is equal to or higher than the predetermined voltage level. Consequently, the ON signal and the OFF signal of the brake switch 4 can more reliably be recognized by the CPU 9, and incorrect recognition that the ON signal of the brake switch 4 is OFF, which can result from low voltage of the main switch 3, is better prevented. Other constitutions, operations, and effects can be similar to those in FIG. 2.

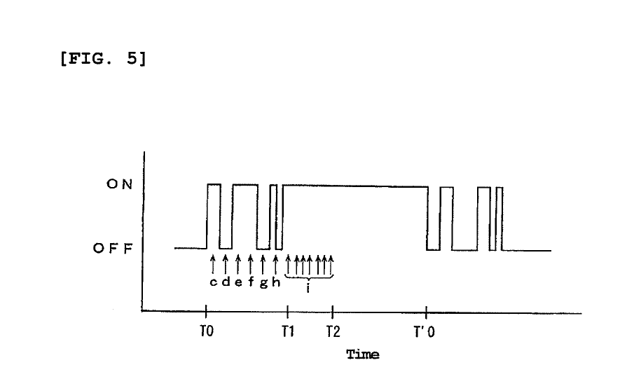

FIG. 5 shows a schematic drawing illustrating how a change in ON/OFF signals of an electrical apparatus can be recognized. The ordinate axis represents switching between ON and OFF while the abscissa represents time.

Additional embodiments of the step S3 and the step S4 (FIG. 1) are described hereinafter in further detail. When the user operates the electrical apparatus to turn the switch from OFF to ON at time T0, the CPU can perform the detection process as described below. The detection by the CPU can be periodically performed as indicated by arrows c to i. Therefore, it can be determined that the release signal is ON in first detection c.

Here, as a change can be caused in the switch, a chattering can occur. Accordingly, the release signal can be determined to be OFF in next detection d. After this, the release signal can be determined to be ON in next detection e and f The release signal may not be set yet because the release signal can be OFF in next detection g. In addition, the release signal can be determined to be OFF in next detection h. The release signal may not be set yet because the release signal can be ON in next detection i. The predetermined number of ON signals can be confirmed in detection i. In other words, the state of a first change in which the release signal is ON can be sustained for the predetermined period of time. Accordingly, the CPU is configured to detect that the input release signal is ON. The predetermined period of time (from T1 to T2) in detection i can be preferably about 40 ms. When the release signal is turned OFF from ON at time T′0, the CPU can perform the same detection to set the release signal.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A release signal authentication method for an immobilizer in which:
a user can turn on a main switch and can manually perform an operation for rotating an engine in a state that a battery is not be mounted or battery voltage is not sufficient for rotating the engine;
a power source is configured to be supplied to a CPU by power generation resulting from rotation of the engine;
a release signal is configured to be input by the user in a state that the engine is rotating; and
an anti-theft device is configured to be released and the rotation of the engine is sustained when the inputted release signal matches with a release signal registered in advance;
the method comprising:
inputting the release signal by operating an electrical apparatus using voltage supplied by turning on the main switch;
detecting the inputted release signal with the CPU only when a voltage amount supplied to the main switch is equal to or higher than a voltage amount that the CPU can recognize that the main switch is in an ON-state.

2. The release signal authentication method of an immobilizer according to claim 1, additionally comprising detecting the voltage level supplied to the main switch with an analog-to-digital converter.

3. The release signal authentication method for an immobilizer according to claim 1, characterized in that a first transistor is connected between the main switch and the CPU, a second transistor is connected between the electrical apparatus and the CPU, wherein the method further comprises setting a first voltage detection sensitivity of the first transistor to a detection sensitivity lower than a second voltage detection sensitivity of the second transistor.

4. The release signal authentication method for an immobilizer according to claim 1, additionally comprising determining that a release signal is being input only if a state of the release signal received by the CPU changes for a predetermined period of time as the release signal is inputted by the user.

5. The release signal authentication method for an immobilizer according to claim 2, additionally comprising determining that a release signal is being input only if a state of the release signal received by the CPU changes for a predetermined period of time as the release signal is inputted by the user.

6. The release signal authentication method for an immobilizer according to claim 3, additionally comprising determining that a release signal is being input only if a state of the release signal received by the CPU changes for a predetermined period of time as the release signal is inputted by the user.

7. A release signal authentication method for an immobilizer of a vehicle having an engine, the method comprising:
determining if a first output voltage of a main switch of the vehicle is greater than a first predetermined voltage level;
detecting an output signal of an electrical apparatus of the vehicle only if the first output voltage is greater than the first predetermined voltage level;
comparing the output signal of the electrical apparatus to a predetermined release code of the immobilizer; and
allowing the engine to continue to operate if the output signal of the electrical apparatus matches the release code.

8. The method according to claim 7 additionally comprising determining if a high voltage level of the output signal is greater than a second voltage level.

9. The method according to claim 8 wherein the step of detecting an output signal of the electrical apparatus comprises detecting the output signal only if the high voltage level of the output signal is greater than the second voltage level, which is lower than the first predetermined voltage level.

10. The method according to claim 7 additionally comprising allowing the engine to operate before the step of comparing the output signal of the electrical apparatus.

11. The method according to claim 7 additionally comprising stopping the engine if the output signal of the electrical apparatus does not match the release code.

12. The method according to claim 10 additionally comprising stopping the engine if the output signal of the electrical apparatus does not match the release code.

13. An immobilizer apparatus for a vehicle having an engine, the immobilizer apparatus comprising:
an electrical apparatus configured to be actuatable by a user of the vehicle and to output an output signal corresponding to actuation;
a central processing unit (CPU) having a release code stored therein, the release code corresponding to a predetermined pattern of actuation of the electrical apparatus;
a main switch that a user can turn on;
a power source configured to supply power to the CPU by power generation resulting from rotation of the engine;
wherein the CPU is configured to recognize that the main switch is activated only if the voltage received from the main switch is equal to or greater than a first predetermined voltage value, wherein the CPU is configured to detect signal changes from the electrical apparatus only if an output signal of the electrical apparatus is greater than a second voltage value that is less than the first predetermined voltage value, and wherein the CPU is configured to compare the output signal of the electrical apparatus with the release code and to allow the engine to continue to operate only if the output signal corresponds to the release code.

14. The immobilizer apparatus according to claim 13, wherein the voltage level supplied to the CPU from the main switch is detected by an analog-to-digital converter.

15. The immobilizer apparatus according to claim 13, wherein a first transistor is electrically connected between the main switch and the CPU, a second transistor is electrically connected between the electrical apparatus and the CPU, and wherein a voltage detection sensitivity of the first transistor is lower than a voltage detection sensitivity of the second transistor.

16. The immobilizer apparatus according to claim 13, wherein the CPU is configured to detect changes in the output signal of the electrical apparatus only if the output signal changes for a predetermined period of time.

17. The immobilizer apparatus according to claim 14, wherein the CPU is configured to detect changes in the output signal of the electrical apparatus only if the output signal changes for a predetermined period of time.

18. The immobilizer apparatus according to claim 15, wherein the CPU is configured to detect changes in the output signal of the electrical apparatus only if the output signal changes for a predetermined period of time.

19. An immobilizer apparatus for a vehicle having an engine, the immobilizer apparatus comprising:
an electrical apparatus configured to be actuatable by a user of the vehicle and to output an output signal corresponding to actuation;
a storage device having a release code stored therein, the release code corresponding to a predetermined pattern of actuation of the electrical apparatus;
a main switch that a user can turn on;
a power source configured to supply power to the main switch and the electrical apparatus from rotation of the engine; and
means for recognizing that the main switch is activated only if the voltage received from the main switch is equal to or greater than a first predetermined voltage value, for detecting signal changes from the electrical apparatus only if an output signal of the electrical apparatus is greater than a second voltage value that is less than the first predetermined voltage value, and for comparing the output signal of the electrical apparatus with the release code and for allowing the engine to continue to operate only if the output signal corresponds to the release code.
